(19) United States
(12) Patent Application Publication
(10) Pub. No.: US 2007/0245159 A1
(43) Pub. Date: Oct. 18, 2007

(54) Hash function strengthening

(75) Inventor: Paul Youn, Redwood City, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, REDWOOD SHORES, CA (US)

(21) Appl. No.: 11/405,738

(22) Filed: Apr. 18, 2006

(51) Int. Cl. H04L 9/00; G06F 12/14; H04L 9/32; G06F 11/30

(52) U.S. Cl. 713/187; 713/181

(57) ABSTRACT

Systems, methods, media, and other embodiments associated with hash functions are described. One example system embodiment includes logic for computing a first hash for a first data set, logic for manipulating the first data set into a second data set, and logic for computing a second hash for the second data set. The example system embodiment may also include logic for producing a signature from the first hash and/or the second hash.

### BACKGROUND

Hashing functions may be used to verify the integrity of input data. For example, a first user may cause an input data (e.g., message) to be processed through a hash function to produce an output data (e.g., hash). The input data and the output data may then be provided to a second user. The second user may also cause the input data to be processed through a hash function. If the hash produced by the receiver matches the hash produced by the first user then the second user may have some confidence level in the integrity of the received message. The confidence level may be increased if the input data and/or the output data are protected by a method (e.g., encryption) that may produce a signature designed to avoid an attack where both the input data and output data are replaced.

Hash functions generally exhibit the following behaviors:
(1) producing a fixed sized output regardless of input size;
(2) resisting collisions; and
(3) resisting pre-imaging.

Thus, hash functions have been employed in security-related applications including calculating digital signatures, verifying text integrity, and so on. However, some hash functions may be susceptible to brute force attacks whose processing requirements may soon be met by steadily increasing computing power and/or improvements in cryptanalysis. For example, the SHA-1 hash algorithm (Secure Hash Algorithm, 1) provided by NIST (National Institute of Standards and Technology) is one of a class of hash functions that returns one of k equally likely values when supplied with a random input, k being an integer. Using a birthday attack that simply repeatedly evaluates a hash function using different inputs, a collision (e.g., duplicate output) is expected to be found in approximately 1.2*k^{1/2} tries. In SHA-1, k=2¹⁶⁰. Thus a collision may be expected in 1.2*2⁸⁰ attempts, which current or future computing systems may perform in a viable time frame. While a pure brute force attack is predicted to find a collision in approximately 1.2*k^{1/2} tries, attacks have been described that in practice may find collisions in approximately 2*⁶⁹ attempts.

### BRIEF DESCRIPTION OF THE DRAWINGS

The accompanying drawings, which are incorporated in and constitute a part of the specification, illustrate various embodiments of example systems, methods, and so on described herein. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates data processed by a block-oriented hash function.

FIG. 2 illustrates an example hash related method.

FIG. 3 illustrates an example hash using method.

FIG. 4 illustrates an example hash strengthening method.

FIG. 5 illustrates an example hash related system.

FIG. 6 illustrates an example hash strengthening system.

FIG. 7 illustrates an example computing environment in which example systems and methods illustrated herein can operate.

FIG. 8 illustrates an example application programming interface (API).

FIG. 9 illustrates an example database management system that includes a hash strengthening logic.

FIG. 10 illustrates an example hash strengthening method.

### DETAILED DESCRIPTION

Hashing functions generally produce a fixed size output regardless of the size of the input. For example, a hash function may produce a 64-bit integer regardless of whether it processes a 1 kilobyte (Kb) message, a 1 megabyte (Mb) message, or a 1 gigabyte (Gb) message. The 64-bit integer provides 2⁶⁴ different possible outputs for the hash function. At earlier points in time this was a practically un-computable number of possibilities to decipher. As computing power has increased, 64-bit integer hashes have become obsolete. Thus, stronger hashing functions with increased output sizes and more complex algorithms have been employed. However, simply increasing the output size has not resolved one fundamental issue with conventional hashing approaches.

In conventional approaches, an input message is generally divided into a set of blocks of fixed size. A final block may be “padded” so that it matches the fixed block size. Unfortunately, substituting a block that has the same hash value as an original block may preserve a hash value for an entire message. This may make a hash function more susceptible to attack.

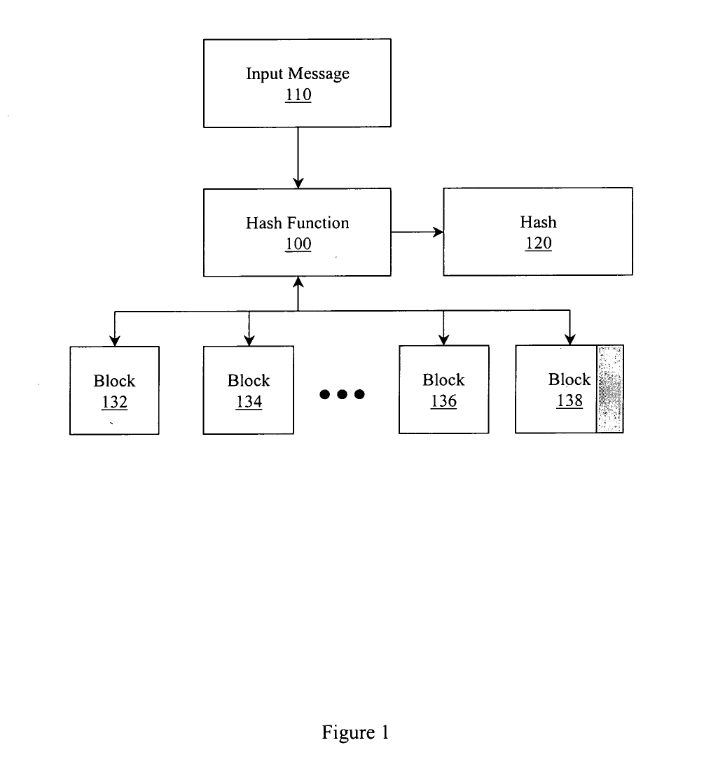

FIG. 1 illustrates data processed by a typical block-oriented function (e.g., Merkle-Damgard hash function, SHA-1). A block-oriented hash function 100 processes an arbitrary length input message 110 and produces a fixed length output (e.g., hash 120). The function 100 breaks the input message 110 into a series {e.g., 132, 134, . . . 136} of equal sized blocks and pads a final block 138 as necessary. The function 100 and more generally this type of function then operates on the series of blocks in sequence and produces a fixed length output. While producing the fixed length output, a set of variables associated with a hash function and/or a hash logic may be manipulated on a per block basis. In one example, after all blocks have been processed, the set of variables may be used to produced the final fixed length output. The pre-determined block approach may make this type of hash function susceptible to an attack like a birthday attack.

A birthday attack is a class of brute force technique asserted against hash functions used in cryptographic applications. A birthday attack exploits hash functions that use a pre-determined block approach and that return one of k values when supplied with a random input (k being an integer). Consider the SHA-1 hash function, which returns a hash having 160 bits. By repeatedly evaluating the hash function against different inputs, a brute force attack (e.g., birthday attack) would be expected to find a collision block in approximately 1.2*2⁸⁰ tries while a reported attack may find a collision block in 2⁶⁹ tries. In block based hash function processing, replacing an original block with a collision block may preserve the hash for the entire message.

The acts of finding a collision block, or more generally finding a collision message, concern the collision resistance property of a hash function. The collision resistance property may be described as follows:
For a hash function h(x), it should be rare to practically impossible (e.g., un-computable in a useful period of time) to find any input data m & n, m !=n, where h(m)=h(n).

Digital signatures rely on the collision resistance of hash functions. However, if any two messages can be found to collide, then the hash function is considered to be broken for producing digital signatures. Example systems and methods described herein concern processing associated with a hash function that may make a hash less susceptible to attack.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Machine-readable medium”, as used herein, refers to a medium that participates in directly or indirectly providing signals, instructions and/or data. A machine-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and so on. Transmission media can also take the form of electromagnetic radiation, like that generated during radio-wave and infra-red data communications, or take the form of one or more groups of signals. Common forms of a machine-readable medium include, but are not limited to, a floppy disk, a flexible disk, a hard disk, a magnetic tape, other magnetic medium, a CD-ROM (Compact Disk Read Only Memory), other optical medium, punch cards, paper tape, other physical medium with patterns of holes, a RAM (Random Access Memory), a ROM (Read Only Memory), a PROM (Programmable ROM), an EPROM (Erasable PROM), a FLASH-EPROM, or other memory chip or card, a memory stick, a carrier wave/pulse, and other media from which a machine (e.g., computer), a processor or other electronic device can read. Signals used to propagate instructions or other software over a network, like the Internet, can be considered a “machine-readable medium.” A computer-readable medium may be considered a machine-readable medium.

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, and so on. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, on the environment in which it runs, on the desires of a designer/programmer, and so on. It will also be appreciated that machine-readable and/or executable instructions can be located in one logic and/or distributed between two or more communicating, co-operating, and/or parallel processing logics and thus, in some examples, can be loaded and/or executed in serial, parallel, massively parallel and other manners.

Software suitable for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a machine-readable medium as defined previously. Another form of the software may include signals that transmit program code of the software to a recipient over a network or other communication medium. Thus, in one example, a machine-readable medium has a form of signals that represent the software/firmware as it is downloaded from a web server to a user. In another example, the machine-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, calculating, determining, displaying, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methods are shown and described as a series of blocks, it is to be appreciated that the methods are not limited by the order of the blocks, as some blocks can occur in different orders and/or concurrently with other blocks from that shown and described. Moreover, less than all the illustrated blocks may be required to implement an example method. Blocks may be combined or separated into multiple components. Furthermore, additional and/or alternative methods can employ additional, not illustrated blocks. While the figures illustrate various actions occurring in serial, it is to be appreciated that various actions could occur concurrently, substantially in parallel, and/or at substantially different points in time.

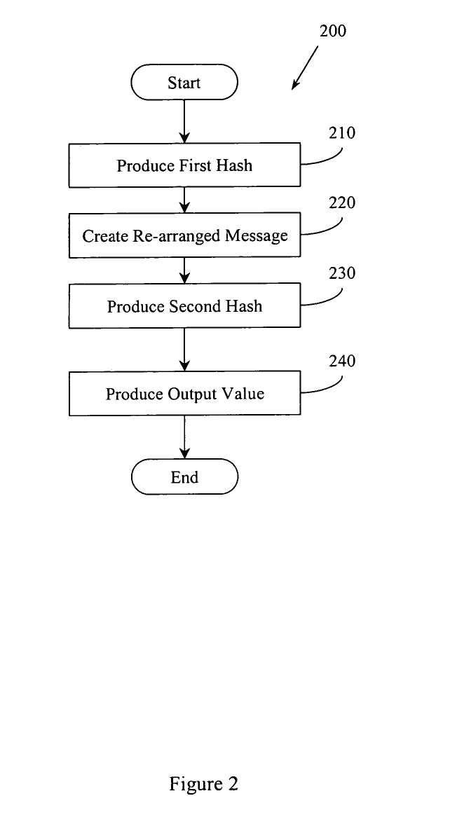

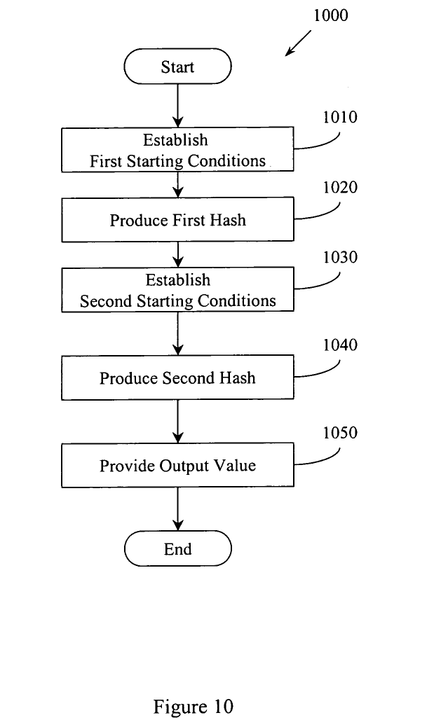

FIG. 2 illustrates an example method 200. Method 200 interacts with hash functions and produces an output that may be less susceptible to attack than a hash. This may be referred to as “strengthening a hash function”. Method 200 addresses a weakness in block-oriented hash functions. Method 200 involves calculating two hashes using two different versions of a message. In one example, a first hash is produced for a message using a conventional (e.g., SHA-1) hash. This hash may then be used as an input to a re-arranging function (e.g., rotation function). The rotation function may output a number of bits by which the message is to be rotated. In one example, the number of bits may be in the range of one bit up to the size of the input (or input block). The message may then be rotated by that number of bits. A second hash may then be produced for the rotated message to produce a final result. In another example, the two hashes may be combined (e.g., logical XOR) to produce a final result. In one example, the final result may be provided as an input to a digital signature function. As described above, a hash function or hash logic may rely on internal variables (e.g., state variables) that have initial values and that are manipulated on a per block basis. Thus, in one example, as illustrated in FIG. 10, the first hash may be used to manipulate internal variables associated with producing a second hash.

Method 200 may include, at 210, producing a first hash for a message. Method 200 may also include, at 220, creating a re-arranged message from the message. In one example, creating the re-arranged message includes rotating the message by a number of bits. The number of bits by which the message is rotated may be, for example, a pre-determined constant. The number of bits by which the message is rotated may also be, for example, a value returned as an output from a function that receives the first hash as an input.

In another example, creating the re-arranged message includes altering the message in a number of positions. The number of positions may be, for example, a pre-determined constant, a value based on the first hash, and so on. In different examples altering the message may include inverting a byte, adding a value to a byte, subtracting a value from a byte, swapping a byte at a first position with a byte at a second position, rearranging blocks in the input message, and so on.

In one example the message may be partitioned into blocks. Thus, creating the re-arranged message may include re-arranging data within a block. For example, data may be rotated within a block rather than globally over the entire message.

Method 200 may also include, at 230, producing a second hash for the re-arranged message. In one example, the first hash and the second hash are produced using an identical hash function. In another example, the first hash and the second hash are produced using different hash functions. In this example, more than one second hash function may be available. Thus, which second hash function is selected may depend, for example, on the first hash. In one example, the first hash and the second hash may be produced at least partially in parallel. For example, when the input message is rotated by a pre-determined amount, then the input message may be manipulated while the first hash is being produced. After the manipulation is complete, the second hash may be computed in parallel with the first hash.

Method 200 may also include, at 240, providing an output value. In different examples the output value may be based on the second hash and/or on combinations of the second hash and the first hash. For example, the output value may represent a logical XOR of the first hash and the second hash, may represent a concatenation of the first hash and the second hash, and so on.

While FIG. 2 illustrates various actions occurring in serial, it is to be appreciated that various actions illustrated in FIG. 2 could occur substantially in parallel. By way of illustration, a first process could compute a first hash, a second process could manipulate (e.g., rotate) the input message, and a third process could produce the second hash. While three processes are described, it is to be appreciated that a greater and/or lesser number of processes could be employed and that lightweight processes, regular processes, threads, and other approaches could be employed.

In one example, methods are implemented as processor executable instructions and/or operations stored on a machine-readable medium. Thus, in one example, a machine-readable medium may store processor executable instructions operable to cause a machine to perform a method. The method may include producing a first hash for a message, creating a re-arranged message from the message, producing a second hash for the re-arranged message, and providing an output value that is based, at least in part, on the second hash. While this method is described being stored on a machine-readable medium, it is to be appreciated that other example methods described herein can also be stored on a machine-readable medium.

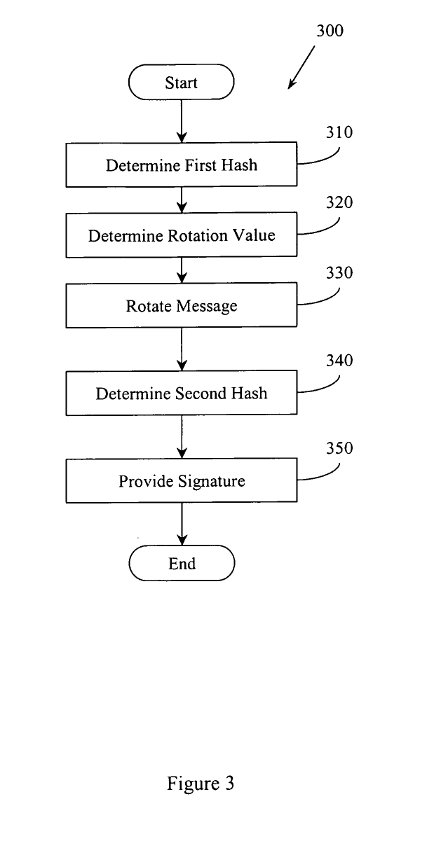

FIG. 3 illustrates a method 300. Method 300 may include, at 310, determining a first hash for a message using a first hash function. Method 300 may also include, at 320, determining a rotation value. The rotation value may be based, for example, on the first hash. By way of illustration, a rotation value may range from one position up to one less than the size of the input message. Which value is selected may be determined by the first hash. For example, a logic may accept the first hash as an input and return the rotation value as an output.

Method 300 may also include, at 330, rotating the message by the rotation value. The resulting message may be called a rotated message. Rotating a message may involve moving (e.g., shifting) message elements (e.g., characters) to new locations. Message elements that are shifted off one end of the message may be shifted back in at the other end. The shift may be physical where data is actually moved and/or logical where data may not be moved but rather pointers may be manipulated to establish new boundaries, new start points, new end points, and so on.

Method 300 may also include, at 340, determining a second hash for the rotated message. In one example, the second hash will be computed using the first hash function. In other examples, the second hash will be computed using a separate and distinct hash function.

Method 300 may also include, at 350, providing a signature. The signature may be produced from the second hash and/or the first hash. In one example, the second hash may be provided as the signature. In another example, the second hash may be combined (e.g., XOR'd together) with the first hash and the result provided as the signature.

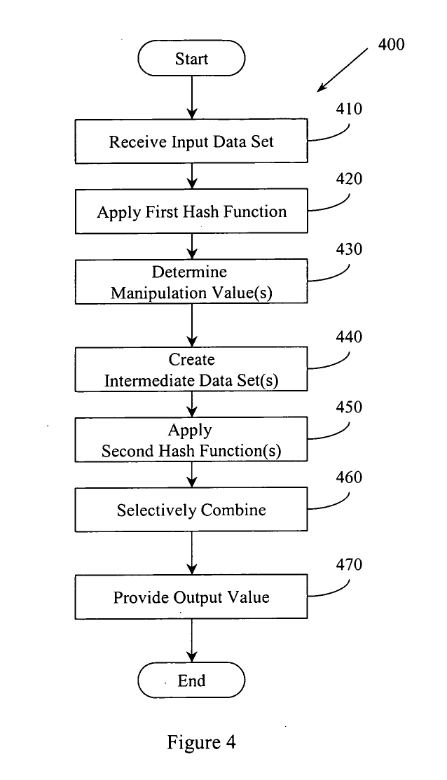

FIG. 4 illustrates a method 400. Method 400 may include, at 410, receiving an input data set. The input data set (e.g., message) may include a data element(s) (e.g., character, byte). Method 400 may also include, at 420, applying a first hash function to the input data set to produce a first hash value. While conventional systems may simply provide this first hash value, method 400 does more.

For example, method 400 may include, at 430, determining a manipulation value(s) using the first hash value. In one example, the first eight bits of the first hash may be used as an integer that describes how and/or where to manipulate the input data set. Thus, method 400 may also include, at 440, manipulating the input data set into an intermediate data set(s). In one example, manipulating the input data set includes rotating the input data set. The amount by which the input data set is rotated may depend, for example, on the manipulation value(s). How and/or where the input data set is manipulated may depend on the manipulation value(s).

In one example, method 400 may also include partitioning the input data set into blocks. Each block may store a data element(s). In this example, manipulating the input data set into an intermediate data set(s) may include rotating data elements in a block rather than rotating the input data set globally. The amount by which data elements in a block are rotated may depend, for example, on the manipulation value(s).

While rotating is described, it is to be appreciated that in other examples other approaches may be taken. By way of illustration, manipulating the input data set into an intermediate data set(s) may include altering a data element. Which data element(s) is altered may be determined by the manipulation value(s). Altering a data element may involve taking actions including, but not limited to, inverting a data element, rotating a data element by a number of bits, adding a value to a data element, subtracting a value from a data element, combining the data element with another data element, and so on. Other manipulations may include, for example, rearranging the message in a deterministic and reproducible manner. One deterministic and reproducible manner may involve rearranging the input block order based on a manipulation value as determined by a manipulation function.

Method 400 may also include, at 450, applying a second hash function(s) to the intermediate data set(s) to produce a second hash value(s). These second hash value(s) may then be selectively combined at 460 into an output value, which is provided at 470. In one example, the first hash value and the second hash values are produced at least partially in parallel.

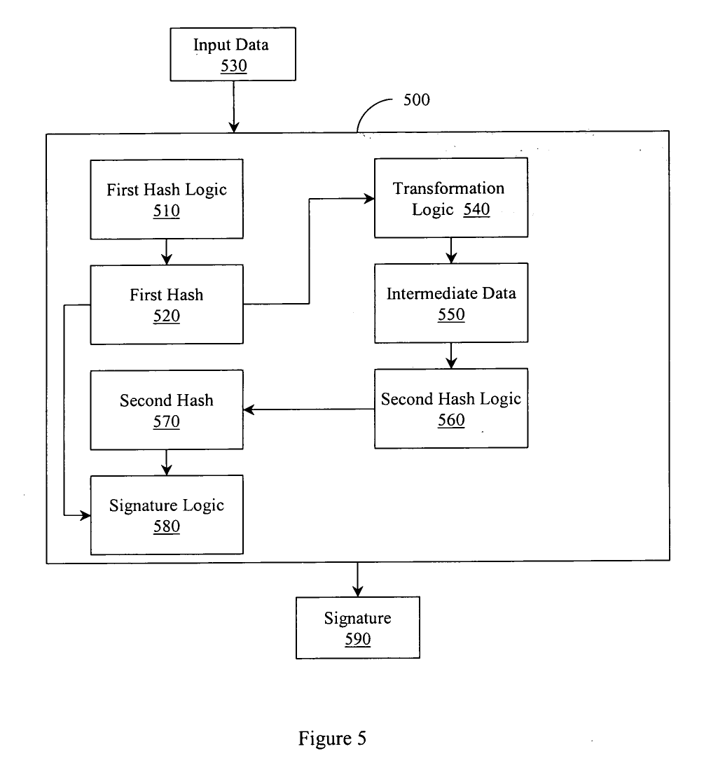

FIG. 5 illustrates a system 500. System 500 may include a first hash logic 510 to produce a first hash 520 associated with an input data 530. Conventional systems might provide first hash 520. However, system 500 includes additional elements that perform additional processing. For example, system 500 may include a transformation logic 540 that manipulates the input data 530 into an intermediate data 550. Manipulating the input data 530 may include, for example, rotating the input data 530 by a number of bits.

System 500 may also include a second hash logic 560 to produce a second hash 570 for the intermediate data 550. Conventional systems typically do not produce the second hash 570. In one example, the intermediate data may be used to manipulate (e.g., establish, alter) starting conditions for the second hash logic. Additionally, system 500 may also include a signature logic 580 to produce a signature 590. The signature 590 may be based, for example, on the second hash 570 and/or on combinations of the second hash 570 and the first hash 520. For example, the signature 590 may be the second hash 570, may be a logical XOR of the first hash 520 and the second hash 570, may be a concatenation of the first hash 520 and the second hash 570, and so on.

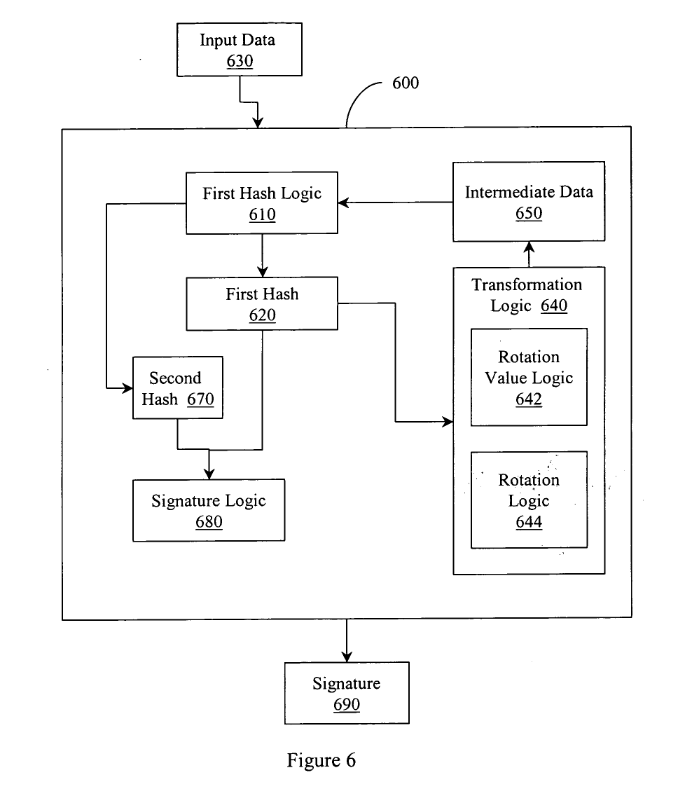

FIG. 6 illustrates a system 600 similar to system 500. For example system 600 includes a first hash logic 610 that produces a first hash 620 from an input data 630. Similarly, the system 600 includes a transformation logic 640 that produces an intermediate data 650. Additionally, the system 600 includes a signature logic 680 that produces a signature 690 from the first hash 620 and a second hash 670.

However, system 600 has some differences from system 500. For example, in the system 600, the transformation logic 640 includes a rotation value logic 642 to determine an amount by which the input data 630 is to be rotated. Additionally, transformation logic 640 includes a rotation logic 644 to rotate the input data 630 by the amount determined by the rotation value logic 642.

Another difference concerns how the second hash 670 is produced. The system 600 includes the first hash logic 610 and does not include a second hash logic. Thus, the first hash 620 and the second hash 670 are computed by the same hash logic, (e.g., first hash logic 610).

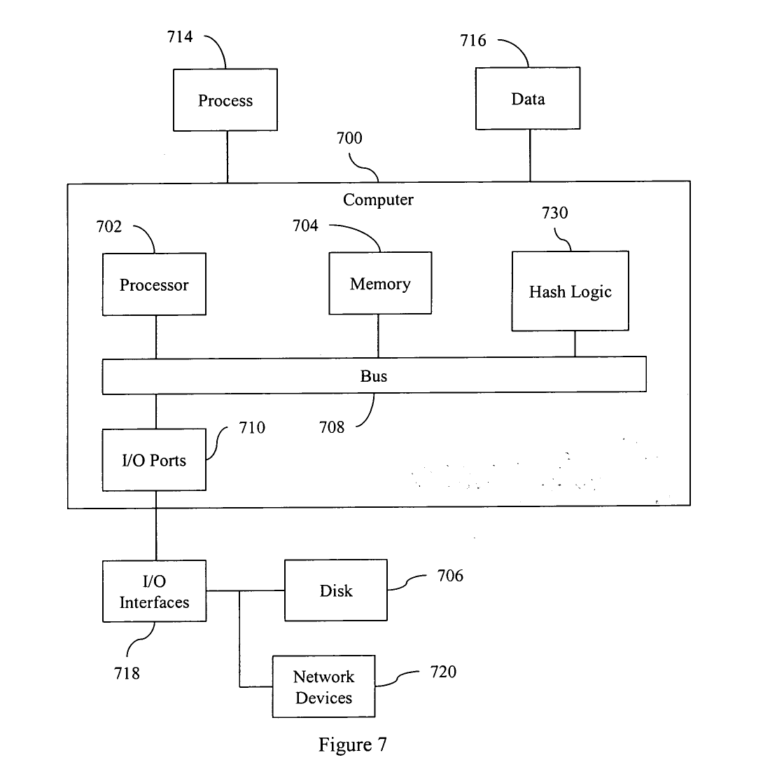

FIG. 7 illustrates an example computing device in which example systems and methods described herein, and equivalents, can operate. The example computing device may be a computer 700 that includes a processor 702, a memory 704, and input/output ports 710 operably connected by a bus 708. In one example, the computer 700 may include a hash logic 730 to facilitate manipulating and strengthening a hashing function. Hash logic 730 may provide means (e.g., hardware, software, firmware) for producing a hash for a message and means (e.g., hardware, software, firmware) for deterministically altering the message into an altered message. The altering may be based on the hash. For example, a number of bits by which the message is to be rotated to produce the altered message may be determined from the hash. Hash logic 730 may also provide means (e.g., hardware, software, firmware) for producing a second hash for the altered message and means (e.g., hardware, software, firmware) for providing a signature for the message. The signature may be crafted from the second hash.

Generally describing an example configuration of the computer 700, the processor 702 can be a variety of various processors including dual microprocessor and other multi-processor architectures. The memory 704 can include volatile memory and/or non-volatile memory. The non-volatile memory can include, but is not limited to, ROM (Read Only Memory), PROM (Programmable ROM), EPROM (Erasable PROM), EEPROM (Electrically Erasable PROM), and so on. Volatile memory can include, for example, RAM (Random Access Memory), synchronous RAM (SRAM), dynamic RAM (DRAM), synchronous DRAM (SDRAM), double data rate SDRAM (DDR SDRAM), and direct RAMbus RAM (DRRAM).

A disk 706 may be operably connected to the computer 700 via, for example, an input/output interface (e.g., card, device) 718 and an input/output port 710. The disk 706 can include, but is not limited to, devices like a magnetic disk drive, a solid state disk drive, a floppy disk drive, a tape drive, a Zip drive, a flash memory card, and/or a memory stick. Furthermore, the disk 706 can include optical drives like a CD-ROM, a CD recordable drive (CD-R drive), a CD rewriteable drive (CD-RW drive), and/or a digital video ROM drive (DVD ROM). The memory 704 can store processes 714 and/or data 716, for example. The disk 706 and/or memory 704 can store an operating system that controls and allocates resources of the computer 700.

The bus 708 can be a single internal bus interconnect architecture and/or other bus or mesh architectures. While a single bus is illustrated, it is to be appreciated that computer 700 may communicate with various devices, logics, and peripherals using other busses that are not illustrated. The bus 708 can be of a variety of types including, but not limited to, a memory bus or memory controller, a peripheral bus or external bus, a crossbar switch, and/or a local bus.

The computer 700 may interact with input/output devices via i/o interfaces 718 and input/output ports 710. Input/output devices can include, but are not limited to, a keyboard, a microphone, a pointing and selection device, cameras, video cards, displays, disk 706, network devices 720, and so on. The input/output ports 710 can include but are not limited to, serial ports, parallel ports, and USB ports.

The computer 700 can operate in a network environment and thus may be connected to network devices 720 via the i/o devices 718, and/or the i/o ports 710. Through the network devices 720, the computer 700 may interact with a network. Through the network, the computer 700 may be operably connected to remote computers. The networks with which the computer 700 may interact include, but are not limited to, a local area network (LAN), a wide area network (WAN), and other networks.

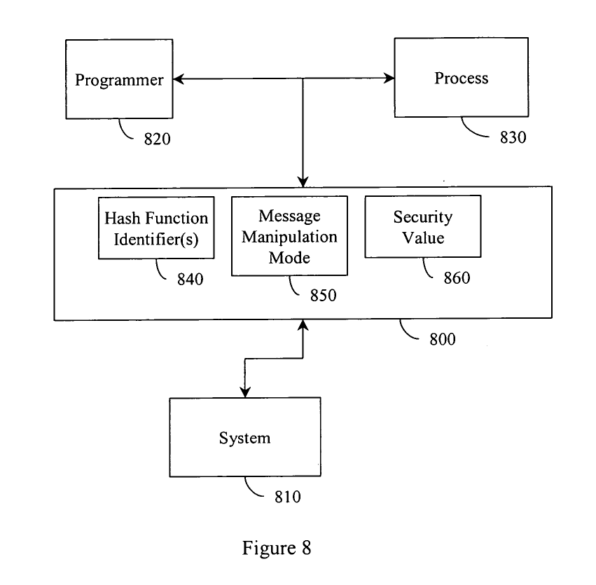

FIG. 8 illustrates an application programming interface (API) 800 that provides access to a hash strengthening system 810. API 800 can be employed, for example, by a programmer 820 and/or a process 830 to gain access to processing performed by system 810 and/or a functionally equivalent method. For example, programmer 820 can write a program to access system 810 (e.g., invoke its operation, monitor its operation, control its operation) where writing the program is facilitated by the presence of API 800. Rather than the programmer 820 having to understand the internals of the system 810, the programmer 820 merely has to learn the interface to the system 810. This facilitates encapsulating the functionality of the system 810 while exposing that functionality.

The API 800 may facilitate providing data values to the system 810 and/or may facilitate retrieving data values from the system 810. For example, a process 830 that verifies hash values can provide a hash function identifier to the system 810 via the API 800 by using a call provided in the API 800. In one example, the API 800 can be stored on a machine-readable medium.

Interfaces in the API 800 can include, but are not limited to, a first interface 840 that communicates a hash function identifier data, a second interface 850 that communicates a message manipulation mode data, and a third interface 860 that communicates a security value produced by applying a hash function(s) identified by the hash function identifier(s) to a message. The hash function(s) may be controlled, for example, by a configurable parameter(s) identified by the message manipulation mode data.

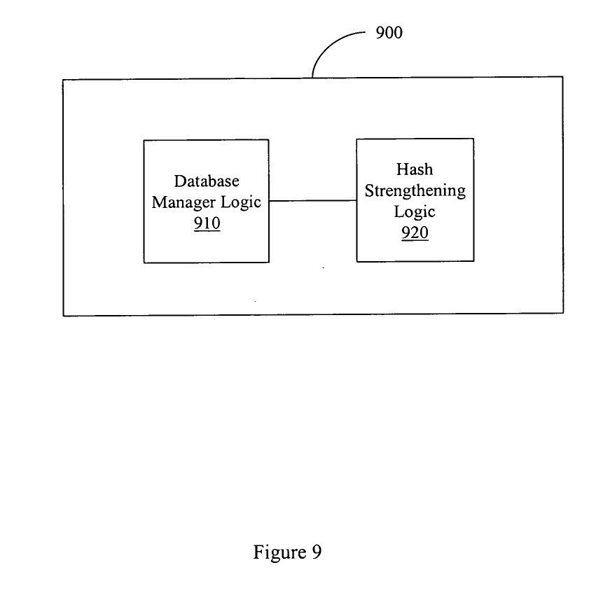

FIG. 9 illustrates an example database management system (DBMS) 900. The DBMS 900 may include a database manager logic 910 and a hash strengthening logic 920. Where a conventional DBMS may communicate a message and a hash produced from the message, DBMS 900 may communicate a message and a strengthened hash produced by hash strengthening logic 920. The hash may be produced according to methods described herein. In one embodiment, a cryptographic signature may be based on the strengthened hash.

FIG. 10 illustrates an example method 1000 for strengthening a hash function. Method 1000 addresses a weakness in block-oriented hash functions. Method 1000 involves calculating two hashes using two different sets of starting conditions (e.g., state variables) for a message. In one example, a first hash is produced for a message using a conventional (e.g., SHA-1) hash. This hash may then be used to establish staring conditions (e.g., state variables) used to produce a second hash.

Method 1000 may include, at 1010, establishing a first set of starting conditions and, at 1020, producing a first hash for a message. Method 1000 may also include, at 1030 establishing a second set of starting conditions. Establishing the second set of starting conditions may include, for example, setting, resetting, altering, manipulating, and so on, variables employed in calculating a hash.

Method 1000 may also include, at 1040, producing a second hash using the second set of starting conditions. In one example, the first hash and the second hash are produced using an identical hash function. In another example, the first hash and the second hash are produced using different hash functions. In this example, more than one second hash function may be available. Thus, which second hash function is selected may depend, for example, on the first hash.

Method 1000 may also include, at 1050, providing an output value. In different examples the output value may be based on the second hash and/or on combinations of the second hash and the first hash. For example, the output value may represent a logical XOR of the first hash and the second hash, may represent a concatenation of the first hash and the second hash, and so on.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A computer-implemented method, comprising:
producing a first hash for a message;
creating a re-arranged message from the message;
producing a second hash for the re-arranged message; and
providing an output value based, at least in part, on the second hash.

2. The method of claim 1, where the first hash and the second hash are produced using an identical hash function.

3. The method of claim 1, where the first hash and the second hash are produced using two different hash functions.

4. The method of claim 3, a second hash function being selected based, at least in part, on the first hash.

5. The method of claim 1, where creating the re-arranged message includes rotating the message by a number of bits.

6. The method of claim 5, the number of bits being one of, a pre-determined constant, and a value based on the first hash.

7. The method of claim 1, where creating the re-arranged message includes altering the message in a number of positions, the number of positions being one of, a pre-determined constant, and a value based on the first hash.

8. The method of claim 7, where altering the message includes one or more of, inverting a byte, adding a value to a byte, subtracting a value from a byte, and swapping a byte at a first position with a byte at a second position.

9. The method of claim 1, the message comprising one or more blocks, and where creating the re-arranged message includes one or more of, re-arranging data within one or more of the blocks, and changing an order in which the one or more blocks are processed to produce the second hash.

10. The method of claim 9, where re-arranging data within one or more of the blocks includes rotating data within one or more of the blocks by a number of positions.

11. The method of claim 10, the number of positions being a pre-determined constant.

12. The method of claim 10, the number of positions being based, at least in part, on the first hash.

13. The method of claim 1, the output value depending, at least in part, on the first hash and the second hash.

14. The method of claim 13, the output value comprising a logical XOR of the first hash and the second hash.

15. The method of claim 13, the output value comprising a concatenation of the first hash and the second hash.

16. The method of claim 1, the first hash and the second hash being produced at least partially in parallel.

17. A machine-readable medium having stored thereon a set of machine-executable instructions that when executed by a machine cause the machine to perform a method, the method comprising:
producing a first hash for a message;
creating a re-arranged message from the message;
producing a second hash for the re-arranged message; and
providing an output value based, at least in part, on the second hash.

18. A computer-implemented method, comprising:
determining a first hash for a message using a first hash function;
determining a rotation value based, at least in part, on the first hash;
rotating the message by the rotation value to create a rotated message;
determining a second hash for the rotated message using the first hash function; and
providing a signature produced from one or more of, the first hash and the second hash.

19. A computer-implemented method, comprising:
receiving an input data set comprising one or more data elements,
applying a first hash function to the input data set to produce a first hash value;
determining one or more manipulation values based, at least in part, on the first hash value;
manipulating the input data set into one or more intermediate data sets based, at least in part, on the one or more manipulation values;
applying one or more second hash functions to the one or more intermediate data sets to produce one or more second hash values;
selectively combining one or more of the second hash values to produce an output value; and
providing the output value.

20. The method of claim 19, where manipulating the input data set into one or more intermediate data sets includes rotating the input data set by an amount determined, at least in part, by the one or more manipulation values.

21. The method of claim 20, including partitioning the input data set into one or more blocks, each block comprising one or more data elements; and
where manipulating the input data set into one or more intermediate data sets includes rotating one or more blocks by amounts determined, at least in part, by the one or more manipulation values.

22. The method of claim 19, where manipulating the input data set into one or more intermediate data sets includes altering one or more data elements, the data elements being determined, at least in part, by the one or more manipulation values, and where altering a data element includes one or more of, inverting a data element, rotating a data element by a number of bits, adding a value to a data element, subtracting a value from a data element, computing the exclusive-or of the data element and another data element, and combining the data element with another data element.

23. The method of claim 19, where the first hash value and the second hash values are produced at least partially in parallel.

24. A system, comprising:
a first hash logic to produce a first hash for an input data;
a transformation logic to manipulate the input data into an intermediate data;
a second hash logic to produce a second hash for the intermediate data; and
a signature logic to produce a signature based on one or more of, the first hash, and the second hash.

25. The system of claim 24, where the first hash logic and the second hash logic perform the same hash function.

26. The system of claim 24, the transformation logic comprising:
a rotation value logic to determine an amount by which the input data is to be rotated, and
a rotation logic to rotate the input data by the amount.

27. The system of claim 24, the signature comprising one of, the second hash, a logical XOR of the first hash and the second hash, and a concatenation of the first hash and the second hash.

28. A database management system, comprising;
a database manager logic; and
a hash function strengthening logic to provide a signature for a message communicated by the database manager logic.

29. A system, comprising:
means for producing a hash for a message;
means for deterministically altering the message into an altered message based, at least in part, on the hash;
means for producing a second hash for the altered message; and
means for providing a signature for the message based, at least in part, on the second hash.

30. A set of application programming interfaces embodied on a computer-readable medium for execution by a computer component in conjunction with producing a hash value for a message, comprising:
a first interface for communicating one or more hash function identifiers;
a second interface for communicating a message manipulation mode; and
a third interface for communicating a security value produced by applying one or more hash functions identified by the one or more hash function identifiers to a message, the one or more hash functions being controlled, at least in part, by one or more configurable parameters identified by the message manipulation mode.

31. A computer-implemented method, comprising:
establishing a first set of starting conditions;
producing a first hash for a message using the first set of starting conditions;
establishing a second set of starting conditions based, at least in part, on the first hash;
producing a second hash for the message using the second set of starting conditions; and
providing an output value based on one or more of, the second hash, and the first hash.

32. The method of claim 31, the first hash and the second hash being produced using one or more of, one hash function, and two different hash functions.

33. The method of claim 31, the second set of starting conditions being set to pre-defined values independent of the first hash.
